(19) United States
(12) Patent Application Publication
(10) Pub. No.: US 2010/0008711 A1
(43) Pub. Date: Jan. 14, 2010

(54) DRY ERASE INK FOR NON-POROUS SURFACES

(75) Inventor: Rainer Kaufmann, Delmenhorst (DE)

Correspondence Address: SQUIRE, SANDERS & DEMPSEY L.L.P., 1 MARITIME PLAZA, SUITE 300, SAN FRANCISCO, CA, 94111, US

(73) Assignee: EDDING AG, AHRENSBURG (DE)

(21) Appl. No.: 12/373,265

(22) PCT Filed: Jul. 10, 2007
(86) PCT No.: PCT/EP07/06097

§ 371 Date: Jan. 9, 2009

(51) Int. Cl. B43K 5/00; C09D 11/16

(52) U.S. Cl. 401/221; 524/321; 524/300; 524/133

(57) ABSTRACT

A dry-erase ink is disclosed for writing or marking on glossy and non-porous surfaces, in particular whiteboards or dry-erase boards, which ink is wipeable or erasable after drying without leaving visible colored residues. The ink contains a solvent, one or more dye(s) soluble in the solvent, a film forming resin such as polyvinylpyrrolidone or a derivative thereof, a strongly-alkaline substance such as a diamine and/or a quaternary organic ammonium hydroxide, an organic acid or a salt thereof and, if desired, a nonvolatile, liquid component serving as a release agent.

### CROSS-REFERENCE

The present application claims priority to German patent application no. 10 2006 032 697.0, which was filed 14 Jul. 2006, the contents of which are incorporated by reference as if fully set forth herein.

### TECHNICAL FIELD

The present invention concerns an ink suitable for application to non-porous and/or glossy surfaces, e.g., whiteboards, wherein the ink can be wiped off or erased from the surface after drying without leaving visible and/or colored residues on the surface.

### BACKGROUND ART

When writing on or marking glossy surfaces, such as whiteboards or dry-erase boards, inks are often utilized that can be wiped or erased after drying without leaving any visible colored residue, so that the surface can be written on again. Such writing boards are characterized in that they typically have hard, white surfaces that are very smooth in appearance and are essentially non-porous.

Conventionally, inks suitable for such applications contain colorants in the form of pigments that are finely distributed in the ink and are maintained in a suspended state by means of a dispersing agent. However, a disadvantageous characteristic of such pigmented liquid inks is that the pigments often precipitate in the ink reservoir, which is provided in or on the writing instrument, prior to use. As a result, the pigment content of the liquid ink is reduced and the images written with this ink are relatively faint.

Inks having dyes soluble therein have not generally been utilized for marking on dry-erase boards, because dyes adhere too strongly to the surfaces of the dry-erase boards after drying and therefore are erasable only with difficulty, or not at all, or require the additional use of a solvent to clean the surface. However, US Patent Publication No. 2006/0063856 has recently proposed dye-containing inks for whiteboard applications.

### DISCLOSURE OF INVENTION

An object underlying the invention is to provide an improved dry-erase ink suitable for use on glossy and/or non-porous surfaces, e.g., whiteboards, which inks have the property of being completely or substantially completely erasable after drying, even though the ink includes one or more dyes that are soluble in a solvent serving as the dye carrier or vehicle.

The present inks contains a solvent, one or more dye(s) soluble in the solvent, a film forming resin such as polyvinylpyrrolidone and/or a derivative thereof, a strongly-alkaline substance such as a diamine and/or a quaternary organic ammonium hydroxide, an organic acid and/or a salt thereof and, optionally, a non-volatile, liquid compound serving as a release agent.

The solvent forms the base liquid, i.e. the dye carrier or dye vehicle, and the other above-mentioned components of the present inks are mixed, or more preferably are dissolved, in the solvent.

Volatile, non-toxic liquids are preferably used as the solvent, such as e.g. alcohols (e.g., ethanol, propanol, butanol, isopropanol), acid esters (e.g., butyl acetate), ether (e.g., propylene glycol monoethyl ether) or ketones (methyl ethyl ketone). The solvents can be used individually or in combinations of two or more solvents. Organic solvents are preferred.

Representative examples of suitable dyes that are dissolvable or soluble, preferably completely or substantially completely dissolvable or soluble, in the solvent include, but are not limited to, the solvent dyes listed in the Color Index, published by the Society of Dyers and Colourists and the American Association of Textile and Chemists and Colorists, which dyes are incorporated herein by reference. The preferred dyes are listed under the category “Solvent Dyes”.

Further examples of suitable dyes include, but are not limited to, Orasol® Blue BL (produced by Ciba-Specialty Chemicals), Neozapon® Black X59 (produced by BASF) and Neozapon® Red 471 (produced by BASF).

Pure dyes or mixtures of different dyes can be utilized in accordance with present teachings.

The dye or the dye mixture is preferably utilized in an amount of 0.5 to 10 weight % based upon the total weight of the ink. When fluorescent dyes are utilized, the amount of utilized dye preferably amounts to 0.5 to 4 weight %, more preferably 0.5 to 2.5%, based upon the total weight of the ink.

As the film forming resin, polyvinylpyrrolidone (PVP) is preferably used as such or in a mixture, e.g., with a vinyl acetate. In addition or in the alternative, a derivative of polyvinylpyrrolidone can also be used alone or in combination with another compound that facilitates the formation of a film upon application to a non-porous surface. Relatively low molecular weight polyvinylpyrrolidones are particularly preferred. Representative examples of suitable film forming resins include, but are not limited to, Polyvinylpyrrolidone 30 or Povidon® K30 (obtainable from Fluka), Luviskol® (produced by BASF) and Kollidon® (produced by BASF). The PVP or the derivative thereof is preferably utilized in an amount from 1 to 10 weight %, more preferably from 3 to 8 weight %, based upon the total weight of the ink.

In addition, modified polyvinylpyrrolidone polymers, such as polyvinyl acetate-modified polyvinylpyrrolidone, may also be used. Furthermore, other examples of useful film forming resins include, but are not limited to, natural resins, such as gum arabic, rosin, or shellac, modified rosins such as rosin esters, hydrogenated rosins, rosin-modified maleic acid resins or rosin-modified phenol resins, phenol resins, cellulosic resins such as ethyl cellulose resins or acetyl cellulose resins, ketone resins, polyvinyl alcohol, polyvinyl acetate resins, petroleum resins, polyvinyl butyral resins, vinylpyrrolidone-vinyl acetate copolymer resins (e.g., Luviskol® VA 37E) and/or polyacrylic acid ester resins. Mixtures of two or more of these film forming resins may also be employed in accordance with the present teachings.

As the strongly-alkaline substance, hydroxides and/or amines are preferably used. Examples of suitable hydroxides include, but are not limited to, quaternary organic ammonium hydroxides such as a tetraalkyl (preferably C1-C4) ammonium hydroxide and a benzyl trialkyl (preferably C1-C4) ammonium, more preferably, tetraethyl ammonium hydroxide and benzyl trimethyl ammonium hydroxide. Examples of suitable amines include, but are not limited to, diamines, such as e.g., diaminohexane, ethylenediamine and hydroxyethylenediamine. The strongly-alkaline substance is preferably utilized in an amount from 0.1 to 3 weight %, more preferably from 0.5 to 2 weight %, based upon the total weight of the ink.

Representative examples of the organic acid include, but are not limited to, a fatty acid or a derivative thereof, a dicarboxylic acid or a derivative thereof, or a phosphoric acid derivative. Representative examples of the fatty acid include, but are not limited to, lauric acid and palmitic acid. Representative examples of the dicarboxylic acid or the derivatives thereof include, but are not limited to, succinic acid, adipic acid, sebacic acid, sulfosuccinic acid—sodium salt and palmitoyl ascorbic acid. A representative, non-limiting example of the phosphoric acid derivative is tridecyl phosphoric acid. The organic acid is preferably utilized in an amount from 0.1% to 5 weight %, more preferably from 0.5 to 3 weight %, based upon the total weight of the ink.

A non-volatile, liquid compound optionally may be utilized as a release agent in order to make the dried ink more easily erased or wiped. Preferred release agents according to the present teachings are esters, such as (without limitation) monocarboxylic acid esters, such as e.g., butyl stearate, glycerin fatty acid ester, such as e.g., glyceryl tricaprylate, oleac acid esters or dicarboxylic acid esters, such as adipin acid 2-ethylhexyl ester, sebacic acid 2-ethylhexyl ester, phthalic acid ester, and/or phosphoric acid ester. The above-mentioned esters can be used individually or in combinations thereof. The release agent is preferably used in an amount from 1 to 20 weight %, more preferably from 3 to 12 weight %, based upon the total weight of the ink.

Optionally, the present ink compositions may, when in the form of an erasable marker ink, also advantageously include a humectant, a surfactant, a preservative, a defoamer, and/or a pH adjuster. These materials and their functions are well known, and their mention herein is by way of illustration only. Generally, any effective amount of the additive may be used so long as the stability of the ink composition is not adversely affected and the ink composition remains suitable for its desired use.

The present inks are stable over a long time, provide robust written images in accordance with the utilized dye and can be wiped off or erased from the glossy and/or non-porous surface after drying without leaving visible residues.

While not wishing to be bound by theory, it is believed that the advantageous properties of the present ink can be attributed to the formation of a complex comprising the utilized dye and the other components contained in the ink, in particular the film forming resin (e.g., polyvinylpyrrolidone) and the strongly-alkaline substance (e.g., diamine), which complex prevents or hinders the dye from permeating into the surface of the object, onto which the ink has been applied.

The present inks are usable on all commercially-available boards, in particular whiteboards, as are widely available for presentation purposes and in schools. The surfaces are comprised, e.g., of polyethylene, polypropylene, polyamide, PVC, melamine resin, enamel, etc.

The present inks may be supplied in a delivery system, such as a marking or writing instrument, preferably for marking or drawing on impervious surfaces such as whiteboards. A representative writing instrument includes a reservoir containing the present ink composition and may generally take the form of any conventional marker. For example, the writing instrument may have a nib, preferably a porous, resilient nib, capable of wicking ink from the ink reservoir by capillary action and applying the ink to the surface. Preferred nibs include, but are not limited to, bonded fiber nibs, felt nibs and sintered plastic nibs. The marker reservoir containing the ink can be any standard marker delivery system including, but not limited to, acetate, polyester, or polypropylene fiber systems. In addition, a fiberless system may be used.

Representative formulations for 3 different-colored inks are provided in the following examples. The percent indications are based upon the total weight of the ink.

### EXAMPLE 1

### Blue Ink

3% Polyvinylpyrrolidone K30
8% Butyl stearate
1% Sulfosuccinic acid ester, sodium salt
1% Diaminohexane
1% Silicon oil L051
3% Orasol® Blue BL
Ethanol q.s. for 100%

### EXAMPLE 2

### Red Ink

3% Luviskol® VA 37E
5% Sebacic acid 2-ethylhexyl ester
2% Tridecyl phosphoric acid
1% Tetraethyl ammonium hydroxide
3% Neozapon® Red 471
Ethanol q.s. for 100%

EXAMPLE 3

### Black Ink

6% Kollidon® 12PF
4% Glyceryl tricaprylate
1% Benzyl trimethyl ammonium hydroxide
2% Lauric acid
5% Neozapon® Black X59
Ethanol q.s. for 100%

1. An ink, which is wipeable or erasable from a glossy and/or non-porous surface, comprising: a solvent,
0.5 to 10 wt. %, based upon the total weight of the ink, of at least one dye that is soluble in the solvent,
1 to 10 wt. %, based upon the total weight of the ink, of a film forming resin, 0.1 to 3 wt. %, based upon the total weight of the ink, of a strongly-alkaline substance, and
0.1 to 5 wt. %, based upon the total weight of the ink, of an organic acid or a salt thereof, characterized in that the strongly-alkaline substance is a diamine and/or a quaternary organic ammonium hydroxide.

2. The ink according to claim 1, wherein the diamine is selected from the group consisting of diaminohexane, ethylene diamine and hydroxyethylene diamine and the quaternary organic ammonium hydroxide is selected from the group consisting of tetraalkyl ammonium hydroxide and benzyl trialkyl ammonium.

3. The ink according to claim 1, wherein the organic acid or a salt thereof is a fatty acid or a derivative thereof, a dicarboxylic acid or a derivative thereof or a phosphoric acid derivative.

4. The ink according to claim 3, wherein the organic acid or a salt thereof is selected from the group consisting of lauric acid, palmitic acid, succinic acid, adipic acid, sebacic acid, sulfosuccinic acid—sodium salt, palmitoyl ascorbic acid and tridecyl phosphoric acid.

5. The ink according to claim 1, further comprising a non-volatile, liquid release agent.

6. The ink according to claim 5, wherein the release agent is selected from the group consisting of butyl stearate, glycerin fatty acid esters, oleac acid esters, adipin acid 2-ethylhexyl ester, sebacic acid 2-ethylhexyl ester, phthalic acid ester and phosphoric acid ester.

7. The ink according to claim 5, wherein the release agent is contained in an amount from 1 to 20 weight % of the total weight of the ink.

8. The ink according to claim 1, wherein the film forming resin comprises polyvinylpyrrolidone or a derivative thereof.

9. The ink according to claim 8, wherein the dye is contained in an amount from 0.5 to 10 weight % and the polyvinylpyrrolidone is contained in an amount from 1 to 10 weight %, both based upon the total weight of the ink.

10. A writing instrument comprising: a reservoir containing an ink according to claim 1, and a nib in fluid communication with the reservoir.

11. A writing instrument comprising: a reservoir containing an ink according to claim 5, and a nib in fluid communication with the reservoir.

12. The ink according to claim 1, wherein the glossy and/or non-porous surface is a whiteboard.

13. The ink according to claim 2, further comprising a non-volatile, liquid release agent.

14. The ink according to claim 3, further comprising a non-volatile, liquid release agent.

15. The ink according to claim 4, further comprising a non-volatile, liquid release agent.

16. The ink according to claim 5, wherein the non-volatile, liquid release agent is an ester.

17. The ink according to claim 6, wherein the release agent is contained in an amount from 1 to 20 weight % of the total weight of the ink.

18. The ink according to claim 7, wherein the release agent is contained in an amount from 1 to 20 weight % of the total weight of the ink.

19. The ink according to claim 5, wherein the film forming resin comprises polyvinylpyrrolidone or a derivative thereof.

20. The ink according to claim 19, wherein the dye is contained in an amount from 0.5 to 10 weight % and the polyvinylpyrrolidone is contained in an amount from 1 to 10 weight %, both based upon the total weight of the ink.
